(19) United States
(12) Patent Application Publication
(10) Pub. No.: US 2010/0112179 A1
(43) Pub. Date: May 6, 2010

(54) AERATED FOOD PRODUCTS BEING WARM CONTAINING SOLUBLE AND/OR INSOLUBLE SOLIDS AND METHODS FOR PRODUCING THEM

(76) Inventors: Andrew Richard Cox, Sharnbrook (GB); Andrew Baxter Russell, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/532,670

(22) PCT Filed: Mar. 6, 2008
(86) PCT No.: PCT/EP08/52716

§ 371 Date: Sep. 23, 2009

(30) Foreign Application Priority Data
Mar. 26, 2007 (EP) 07104916.7

(51) Int. Cl. A23L 1/00; A23C 3/037

(52) U.S. Cl. 426/564; 426/474

(57) ABSTRACT

An aerated food product having an overrun of at least 20%, comprising 40-97% water, 3-50% soluble and/or insoluble solids and hydrophobin, wherein the aerated food product has a temperature of at least 50° C.

### TECHNICAL FIELD OF THE INVENTION

The present invention relates to aerated warm food products and methods for producing them. In particular it relates to aerated food products containing hydrophobin.

### BACKGROUND TO THE INVENTION

Aerated food products, such as ice cream, sorbet, mousse and whipped cream, contain dispersed gas bubbles which provide the desired texture and body to the food product. The visual appearance of food products can also be changed and improved by the incorporation of air bubbles, e.g. whitening or opacifying of a product.

It is difficult to preserve gas bubbles over significant periods of time. This is because a dispersion of gas bubbles is vulnerable to coarsening, i.e. bubble growth by creaming, coalescence and disproportionation. These destabilising processes result in fewer, larger bubbles. Ultimately, these processes can lead to complete foam collapse. As a result of foam loss and bubble coarsening, the product quality deteriorates affecting both visual appearance and texture on consumption. This is undesirable for the consumer.

Further problems may arise when aerated food products are produced in the presence of soluble or insoluble solids, in particular when such aerated food products are to be subjected to a heating step. This is because the thickness, or viscosity, of materials is related to their temperature. Increasing temperature typically leads to a reduction in material viscosity. Therefore, for the case of an aerated product, heating reduces the product viscosity and, as a result, this increases the rate of bubble movement and creaming. This process drives the rate of foam destabilisation and collapse.

For example, the air phase in an aerated product can be stabilised at chill or ambient temperatures by containing a large quantity of solids, i.e. a relatively low water content. However, the viscosity of such products will be significantly reduced on heating. Additionally, both high and low solid content aerated products can be stabilised at chill or ambient temperatures using hydrocolloid stabilisers or thickeners, such as gelatine or polysaccharides, e.g. mousse. However, again, such mixes will exhibit reduced viscosity when the temperature is further elevated, thus driving foam creaming and collapse. Some stabilisers, such as gelatine, “melt” when subjected to elevated temperatures, thus reducing the viscosity and foam stability of the product dramatically. Melt resistant foam stabilisers for such products which do not melt usually give a set texture, i.e. not allowing viscous or creamy liquids.

Even more problematic is the manufacture of such aerated products when additionally fat (due to heating mostly liquid oil) is present. Although foams can be made and stabilised in the presence of substantially solid fats, e.g. in the case of ice cream and whipped cream, it is difficult to create a foam in the presence of liquid oils. This is due to the anti-foaming nature of oils in the presence of air. Secondly, any foam which is formed in the presence of liquid oils tends to be unstable. Bubble coarsening and foam collapse will occur at a faster rate than without the presence of the liquid oil.

As referred to, the problem of creating stable foam is greater when the product is subjected to warm temperature, e.g. 50° C. and above. This reduces the stability of the foam further. For example, it is difficult to keep an aerated product stable when wishing to preserve such aerated compositions by severe heat, as in e.g. heat pasteurising and heat sterilising.

The object of this invention is to create and (physically) preserve the foam in an aerated food product in the presence of 3-50% (preferably 5-30%) (wt) soluble and/or insoluble solids when subjected to a heating step above about 50° C. (such physical preservation or stability as defined below), (preferably above 65° C., more preferably 60-130° C.). Preferably, such products are viscous or creamy liquids (flowable but thicker than water). Preferably, such creation and preservation should still allow preservation by heat (e.g. pasterurisation or sterilisation).

Our co-pending applications EP-A 1 623 631 and EP-1 621 084, disclose aerated food products that contain hydrophobins.

### BRIEF DESCRIPTION OF THE INVENTION

We have now found that by using a hydrophobin, an aerated food product comprising water and soluble and/or insoluble solids can remain stable over time, also when such aerated food products are kept an elevated temperature (above room temperature, e.g. above 50° C.) for a period of time. Accordingly, in a first aspect, the present invention provides an aerated food product having an overrun of at least 20%, comprising 40-97% water, 3-50% (weight %, preferably 5-30%, more preferably 10-25%) soluble and/or insoluble solids, and hydrophobin, wherein the aerated food product has a temperature of at least 50° C., preferably 50-130° C.

In a further aspect, the present invention provides an aerated food product having an overrun of at least 20%, comprising 40-97% water, 3-50% (weight %, preferably 5-30%) of soluble and/or insoluble solids, and hydrophobin, which aerated food product is heat-preserved. In this, it is preferred that the product is pasteurised or sterilised by subjecting to heat.

In the above product, the temperatures mentioned are more preferably 60-100° C., more preferably above 65° C., and also more preferably below 95° C.

Preferably the food product comprises at least 0.001 wt % hydrophobin.

Preferably the hydrophobin is in isolated form.

Preferably the hydrophobin is a class II hydrophobin.

Preferably the food product has an overrun of from 25 to 400%.

The aerated food product according to the present invention can be a viscous or creamy liquid (i.e. flowable but thicker than water). Viscous liquid is not necessarily to be understood as a Newtonian viscous liquid, but rather what is understood by e.g. a kitchen chef as a viscous liquid, meaning still flowable products, but not easily flowable, and rather thick products. Examples of such are e.g. sauces. Typical examples of the creamy liquids are soups.

In a second aspect the present invention provides a process for producing an aerated food product according to the first aspect of the invention, the process comprising:
a) aerating an aqueous composition comprising hydrophobin and soluble and/or insoluble solids to an overrun of at least 20%,
b) applying heat by having at least part of the remaining ingredients of step a) at a temperature of above 50° C. and/or by heating the mixture obtained by step a) to a temperature of above 50° C.

As to the heating, the aim is that the product after the process has a temperature of above 50° C., e.g. because it is to be consumed at such temperature, or presented/offered to the consumer at such temperature, or because heat-preservation steps are applied at some stage during the manufacturing process of the product (e.g. pasteurisation or sterilisation). It will be clear to the person of average skill in the art that such temperature can be achieved by heating the final product, but also by heating part of the ingredients, and if then hot ingredients are mixed with ingredients at e.g. room temperature the resulting end temperature will then be higher than room temperature, or a combination of the above. It is well within the knowledge and ability (by calculation and trial and error) of the person skilled in the art to determine to what temperature an ingredient should be heated at to arrive at a certain end temperature. In the process and product according to the invention, the temperatures mentioned are preferably 50-130° C., more preferably 60-100° C., more preferably above 65° C., and also more preferably below 95° C.

In the process according to the invention it may be preferred that the heating applied in step b) is such that the temperature of the final product has reached at least 50° C., preferably at least 65° C., more preferably at least 50-130° C., preferably below 95° C., optionally followed by cooling.

In the context of this invention, stability of an aerated product is defined as the retention of greater than 50% of the initial overrun of the final product before heating (preferably greater than 60%, more preferably greater than 75%) after the product is subjected to a heating step where the product temperature is over 50° C. for a period of (at least) 2 minutes.

In a related aspect the present invention provides aerated warm (at temperatures above 50° C.) food products containing water and 3-50% (by weight, preferably 5-30%) soluble and/or insoluble solids. Examples of soluble solids are sugars, soluble polysaccharides, salts, mono-sodium glutamate. Examples of insoluble solids are fibres, fruit and vegetable powders and particulates (the insoluble fraction thereof), herbs and spices, meat powder (the insoluble fraction thereof), and others.

The food products according to the present invention may further comprise fat (e.g. 5-55%). Fat in the context of this invention is to be understood to comprise oil, e.g. melted fat. Preferably the fat comprises triglycerides, and preferably at least 60% by weight of such is of vegetable origin. Examples of fats and oils applicable to this invention include milk fat, vegetable oils and hardened vegetable oils, such as sunflower, olive and rapeseed oil, cocoa butter. Also steroid-like fatty matter or matter containing such is included in the definition of “fat”, e.g. cholesterol, egg yolk, (plant)-sterols and -stanols as well as their derivatives. Such fat will usually be present as a dispersed phase. In the present invention, for clarity, the soluble and/or insoluble solids do not encompass fat or oil.

In a third aspect the present invention relates to the use of a hydrophobin to provide an aerated food product as set out above under the first aspect and further defined herein below. In such use, the temperatures mentioned are preferably 50-130° C., more preferably 60-100° C., more preferably above 65° C., and also more preferably below 95° C.

The present invention now allows both manufacture of aerated versions of traditional products like tomato puree, which are stable to heat treatment (such as e.g. heat preservation), as well as allowing manufacturing of entirely new products.

### DETAILED DESCRIPTION OF THE INVENTION

Unless defined otherwise, all technical and scientific terms used herein have the same meaning as commonly understood by one of ordinary skill in the art (e.g. in warm food compositions such as savoury products like e.g. sauces, and in particular in aerated compositions). Standard techniques used for molecular and biochemical methods can be found in Sambrook et al., Molecular Cloning: A Laboratory Manual, 3^{rd} ed. (2001) Cold Spring Harbor Laboratory Press, Cold Spring Harbor, N.Y. and Ausubel et al., Short Protocols in Molecular Biology (1999) 4^{th} Ed, John Wiley & Sons, Inc. —and the full version entitled Current Protocols in Molecular Biology. All percentages, unless otherwise stated, refer to the percentage by weight, with the exception of percentages cited in relation to the overrun (which are defined by the equation below).

### Overrun

The extent of aeration is measured in terms of “overrun”, which is defined as:

$$overrun = \frac{weight of mix - weight of aerated product}{weight of aerated product} \times 100$$

where the weights refer to a fixed volume of product/mix. Overrun is measured at atmospheric pressure.

### Hydrophobins

Hydrophobins are a well-defined class of proteins (Wessels, 1997, Adv. Microb. Physio. 38: 1-45; Wosten, 2001, Annu Rev. Microbiol. 55: 625-646) capable of self-assembly at a hydrophobic/hydrophilic interface, and having a conserved sequence:

(SEQ ID No. 1)

Xₙ-C-X₅₋₉-C-C-X₁₁₋₃₉-C-X₈₋₂₃-C-X₅₋₉-C-C-X₆₋₁₈-C-Xₘ

where X represents any amino acid, and n and m independently represent an integer. Typically, a hydrophobin has a length of up to 125 amino acids. The cysteine residues (C) in the conserved sequence are part of disulphide bridges. In the context of the present invention, the term hydrophobin has a wider meaning to include functionally equivalent proteins still displaying the characteristic of self-assembly at a hydrophobic-hydrophilic interface resulting in a protein film, such as proteins comprising the sequence:

(SEQ ID No. 2)

Xₙ-C-X₁₋₅₀-C-X₀₋₅-C-X₁₋₁₀₀-C-X₁₋₁₀₀-C-X₁₋₅₀-C-
X₀₋₅-C-X₁₋₅₀-C-Xₘ

or parts thereof still displaying the characteristic of self-assembly at a hydrophobic-hydrophilic interface resulting in a protein film. In accordance with the definition of the present invention, self-assembly can be detected by adsorbing the protein to Teflon and using Circular Dichroism to establish the presence of a secondary structure (in general, α-helix) (De Vocht et al., 1998, Biophys. J. 74: 2059-68).

The formation of a film can be established by incubating a Teflon sheet in the protein solution followed by at least three washes with water or buffer (Wosten et al., 1994, Embo. J. 13: 5848-54). The protein film can be visualised by any suitable method, such as labeling with a fluorescent marker or by the use of fluorescent antibodies, as is well established in the art. m and n typically have values ranging from 0 to 2000, but more usually m and n in total are less than 100 or 200. The definition of hydrophobin in the context of the present invention includes fusion proteins of a hydrophobin and another polypeptide as well as conjugates of hydrophobin and other molecules such as polysaccharides.

Hydrophobins identified to date are generally classed as either class I or class II. Both types have been identified in fungi as secreted proteins that self-assemble at hydrophobic interfaces into amphipathic films. Assemblages of class I hydrophobins are relatively insoluble whereas those of class II hydrophobins readily dissolve in a variety of solvents.

Hydrophobin-like proteins (e.g. “chaplins”) have also been identified in filamentous bacteria, such as Actinomycete and Streptomyces sp. (WO01/74864; Talbot, 2003, Curr. Biol, 13: R696-R698). These bacterial proteins by contrast to fungal hydrophobins, may form only up to one disulphide bridge since they may have only two cysteine residues. Such proteins are an example of functional equivalents to hydrophobins having the consensus sequences shown in SEQ ID Nos. 1 and 2, and are within the scope of the present invention.

The hydrophobins can be obtained by extraction from native sources, such as filamentous fungi, by any suitable process. For example, hydrophobins can be obtained by culturing filamentous fungi that secrete the hydrophobin into the growth medium or by extraction from fungal mycelia with 60% ethanol. It is particularly preferred to isolate hydrophobins from host organisms that naturally secrete hydrophobins. Preferred hosts are hyphomycetes (e.g. Trichoderma), basidiomycetes and ascomycetes. Particularly preferred hosts are food grade organisms, such as Cryphonectria parasitica which secretes a hydrophobin termed cryparin (MacCabe and Van Alfen, 1999, App. Environ. Microbiol 65: 5431-5435).

Alternatively, hydrophobins can be obtained by the use of recombinant technology. For example host cells, typically micro-organisms, may be modified to express hydrophobins and the hydrophobins can then be isolated and used in accordance with the present invention. Techniques for introducing nucleic acid constructs encoding hydrophobins into host cells are well known in the art. More than 34 genes coding for hydrophobins have been cloned, from over 16 fungal species (see for example WO96/41882 which gives the sequence of hydrophobins identified in Agaricus bisporus; and Wosten, 2001, Annu Rev. Microbiol. 55: 625-646). Recombinant technology can also be used to modify hydrophobin sequences or synthesise novel hydrophobins having desired/improved properties.

Typically, an appropriate host cell or organism is transformed by a nucleic acid construct that encodes the desired hydrophobin. The nucleotide sequence coding for the polypeptide can be inserted into a suitable expression vector encoding the necessary elements for transcription and translation and in such a manner that they will be expressed under appropriate conditions (e.g. in proper orientation and correct reading frame and with appropriate targeting and expression sequences). The methods required to construct these expression vectors are well known to those skilled in the art.

A number of expression systems may be used to express the polypeptide coding sequence. These include, but are not limited to, bacteria, fungi (including yeast), insect cell systems, plant cell culture systems and plants all transformed with the appropriate expression vectors. Preferred hosts are those that are considered food grade—‘generally regarded as safe’ (GRAS).

Suitable fungal species, include yeasts such as (but not limited to) those of the genera Saccharomyces, Kluyveromyces, Pichia, Hansenula, Candida, Schizo saccharomyces and the like, and filamentous species such as (but not limited to) those of the genera Aspergillus, Trichoderma, Mucor, Neurospora, Fusarium and the like.

The sequences encoding the hydrophobins are preferably at least 80% identical at the amino acid level to a hydrophobin identified in nature, more preferably at least 95% or 100% identical. However, persons skilled in the art may make conservative substitutions or other amino acid changes that do not reduce the biological activity of the hydrophobin. For the purpose of the invention these hydrophobins possessing this high level of identity to a hydrophobin that naturally occurs are also embraced within the term “hydrophobins”.

Hydrophobins can be purified from culture media or cellular extracts by, for example, the procedure described in WO01/57076 which involves adsorbing the hydrophobin present in a hydrophobin-containing solution to surface and then contacting the surface with a surfactant, such as Tween 20, to elute the hydrophobin from the surface. See also Collen et al., 2002, Biochim Biophys Acta. 1569: 139-50; Calonje et al., 2002, Can. J. Microbiol. 48: 1030-4; Askolin et al., 2001, Appl Microbiol Biotechnol. 57: 124-30; and De Vries et al., 1999, Eur J. Biochem. 262: 377-85.

The amount of hydrophobin present in the food product will generally vary depending on the formulation and volume of the gas phase. Typically, the food product will contain at least 0.001 wt %, hydrophobin, more preferably at least 0.005 or 0.01 wt %. Typically the food product will contain less than 1 wt % hydrophobin. The hydrophobin can be from a single source or a plurality of sources e.g. the hydrophobin can be a mixture of two or more different hydrophobin polypeptides.

The hydrophobin is added in a form and in an amount such that it is available to stabilise the gas phase, i.e. the hydrophobin is deliberately introduced into the food product for the purpose of taking advantage of its foam stabilising properties. Consequently, where ingredients are present or added that contain fungal contaminants, which may contain hydrophobin polypeptides, this does not constitute adding hydrophobin within the context of the present invention.

Typically, the hydrophobin is added to the food product in a form such that it is capable of self-assembly at a gas-liquid surface.

Typically, the hydrophobin is added to the food product of the invention in an isolated form, typically at least partially purified, such as at least 10% pure, based on weight of solids. By “isolated form”, we mean that the hydrophobin is not added as part of a naturally-occurring organism, such as a mushroom, which naturally expresses hydrophobins. Instead, the hydrophobin will typically either have been extracted from a naturally-occurring source or obtained by recombinant expression in a host organism.

In one embodiment, the hydrophobin is added to the food product in monomeric, dimeric and/or oligomeric (i.e. consisting of 10 monomeric units or fewer) form. Preferably at least 50 wt % of the added hydrophobin is in at least one of these forms, more preferably at least 75, 80, 85 or 90 wt %. Once added, the hydrophobin will typically undergo assembly at the gas/liquid interface and therefore the amount of monomer, dimer and oligomer would be expected to decrease.

### Other Ingredients

Aerated and aeratable compositions within the scope of this invention may additionally contain other ingredients such as one or more of the following: fat, cheese, egg or egg components, proteins such as dairy proteins or soy protein; sugars e.g. sucrose, corn syrups, sugar alcohols; salts; acids; colours and flavours; fruit or vegetable purees, fruit or vegetable powders, extracts, pieces or juice; stabilisers or thickeners, such as polysaccharides, e.g. locust bean gum, guar gum, carrageenan, microcrystalline cellulose, starch, flour; emulsifiers, such as mono or di-glycerides of saturated or unsaturated fatty acids.

Aerated Food Products and Processes for Preparing them

The term “aerated” means that gas has been intentionally incorporated into a mix, for example by mechanical means. The gas can be any gas, but is preferably, in the context of food products, a food-grade gas such as air, nitrogen, nitrous oxide, or carbon dioxide.

Preferably the food product has an overrun of at least 20%, more preferably at least 50%, most preferably at least 80%. Preferably the food product has an overrun of at most 400%, more preferably at most 200%, most preferably at most 120%.

The aeration step can be performed by any suitable method. Methods of aeration include (but are not limited to):
continuous whipping in a rotor-stator device such as an Oakes mixer (E.T. Oakes Corp), a Megatron mixer (Kinematica AG) or a Mondomix mixer (Haas-Mondomix BV);
batch whipping in a device involving surface entrainment of gas, such as a Hobart whisk mixer or a hand whisk;
gas injection, for example through a sparger or a venturi valve;
gas injection followed by mixing and dispersion in a continuous flow device such as a scraped surface heat exchanger,
elevated pressure gas injection, where a gas is solubilised under pressure and then forms a dispersed gas phase on reduction of the pressure. This could occur upon dispensing from an aerosol container.

In some cases, it may be desirable to perform the aeration step in the absence of the fat phase and then mix the aerated preparation with a second mixture, which contains the fat. This two step method might give improved results as it avoids the adsorption of hydrophobin on the fat phase which might render it unavailable for stabilising the air bubbles. The mixing of the aerated preparation with the second mixture could be performed by any suitable mixing method such as (but not limited by):
batch mixing in a stirred bowl, a kitchen blender or an agitated vessel;
continuous mixing using a static mixer or an in-line dynamic mixer.

In addition to hydrophobin, the aerated food products of the invention (and the mixtures from which they are made) may contain other ingredients conventionally found in food products, such as sugars, salt, fruit and/or vegetable material, eggs (or egg yolk or egg white), meat (incl. fowl), fish, stabilisers, colours, flavours and acids. Preferred food products include products which are preferably served warm or which are subjected to a heating step during their preparation of processing, such as mousse, sauce, pastes, soups, potato products such as purees, soufflées, cookies, (baked) confectionary, dressings. Salt (NaCl) is preferably present in an amount of at least 0.01 wt %, preferably at least 0.05 wt %, more preferably at least 0.1 wt % and preferably at most 10 wt % by weight of the total aerated food product

The present invention will now be further described with reference to the following examples which are illustrative only and non-limiting.

### EXAMPLES

A foamed tomato sauce was made in two ways from a foamed conventional tomato puree: one as control containing Hygel as foaming agent, and one containing hydrophobin HFBII as foaming agent. Both were heated to compare the foam stability upon heating. The tomato puree used was commercially available two-times concentrated tomato paste (ex Sainsbury's, UK), which, after the dillution with water and hydrophobin was still present in the foam (before adding oil) in an amount of 40% by weight.

The preparations in these examples were aerated using a hand-held electric whisk (Aerolatte Ltd, Radlett, UK), for around 5 minutes.

### Example 1A

### Comparative Model Tomato Sauce

10 g conventional tomato puree was mixed with 5 g water (mix 1).

0.1 g Hygel (hydrolysed whey protein from Kerry Biosciences Ltd., Ireland) was mixed with 10g water and aerated to approx. 40-50 ml (mix 2).

Mix 1 and mix 2 were then mixed and vigorously stirred to get a product having a total volume of approximately 50 ml (corresponding to an overrun of about 100%), all at room temperature. This product was then heated au-bain-marie (temperature water bath about 90° C.) whilst being stirred with a magnetic stirrer. The foam product collapsed within 1 minute. By this time the product had reached a temperature of approximately 50° C.

### Example 1B

### Model Tomato Sauce with Hydrophobin

10 g conventional tomato puree was mixed with 5 g water (mix 1).

0.1 g hydrophobin HFBII was mixed with 10 g water and aerated to approx. 40-50 ml (mix 2).

Mix 1 and mix 2 were then mixed and stirred to get a product having a total volume of approximately 50 ml (corresponding to an overrun of about 100%), all at room temperature. This product was then heated au-bain-marie (temperature water bath about 90-95° C.) whilst being stirred with a magnetic stirrer. The heat was turned off, and slowly allowing it too cool. The temperature in doing so was above 80° C. for at least 5 minutes. The foam product survived for more than 60 minutes (then the example was terminated), and the temperature reached was about 90° C.

### Example 1C

### Model Tomato Sauce with Hydrophobin and Oil

To the tomato foam of example 1B (when at 90° C.) was added about 5 ml oil. The volume slightly decreased (i.e. some air was lost) but most of the foam persisted.

### Example 2

### Model Cheese Sauce with Hydrophobin

Mix 1 was prepared by mixing 30% (wt) grated cheddar cheese, 40% (wt) cream, and 30% (wt) water. This was heated under stirring to about 80° C. (mix 1).

0.1 g hydrophobin HFBII was mixed with 10 g water and aerated to approx. 40-50 ml (mix 2, room temperature).

Mix 1 and mix 2 were then mixed and blended. The foam did not collapse. On further heating au-bain-marie to 75-90° C. under stirring some air appeared to be lost, but the major volume of the foam was maintained.

The hydrophobin HFBII in the above examples was obtained from VTT Biotechnology, Finland, having been purified from Trichoderma reesei essentially as described in WO00/58342 and Linder et al., 2001, Biomacromolecules 2: 511-517.

Foam stability is judged by following the change in volume as a function of time. This was measured by estimating the total volume of the product at two points in time. Overrun was calculated also by estimating the volumes and using such volumes in the calculation set out in the detailed description of the invention.

### Example 3

### A Heat Stable Aerated Tomato and Basil Sauce

### Ingredients Used:

Hydrophobin HFBII
Water
Bertolli tomato and basil sauce: consists of 1 wt. % protein, 7 wt. % carbohydrate and 1 wt % oil. Imported from Bertolli™ by Unilever UK.

A commercial tomato sauce (Bertolli™ Tomato and Basil) was aerated as follows: 20 mL of an aqueous solution containing 1 wt. % HFBII was aerated to 100 mL volume in order to create a base stock of foam. A Breville electric hand held mixer was used to pre-blend a bottle of Bertolli™ sauce in order to reduce the size of the vegetable pieces. Stock foam was then dispersed gently into to 90 mL of the Bertolli™ sauce until the total volume of the aerated sauce was 150 mL. The concentration of hydrophobin in the product was ca. 0.1 wt. %.

The heat stability was then assessed by heating the aerated sauce on a hotplate (IKA instruments) from room temperature (20° C.) until it reached 85° C. The product was gently stirred through the heating process to ensure an approximately even distribution of heat, and the total volume was measured as a function of temperature. As the sauce was heated, the volume expanded. This can be explained via the relation between pressure, volume, and temperature of a gas. For a given volume of air at constant atmospheric pressure, as the temperature increases the volume also increases. As a result, once the aerated sauce has reached 85° C., the total volume had increased from 150 mL to approaching 200 mL.

The expansion of the aerated sauce as the product is heated demonstrates the stabilising effect of the hydrophobin. Not only does it prevent significant coalescence of bubbles as the product is heated, it also prevents significant coalescence as the bubbles expand due to the heating process.

On subsequent cooling of the aerated sauce, the volume decreased due to the reduction in temperature. However, even after cooling to room temperature, no significant air loss was observed when compared to the pre-heated volume.

This clearly shows that hydrophobin can be used to create an aerated sauce where the air phase is stable through a heating process. In comparison, a similar aerated sauce using 0.1% Hygel as the air stabilising component (instead of hydrophobin) was found to be very unstable. In this case, the air phase completely collapsed when heated to 85° C.

The various features and embodiments of the present invention, referred to in individual sections above apply, as appropriate, to other sections, mutatis mutandis. Consequently features specified in one section may be combined with features specified in other sections, as appropriate.

All publications mentioned in the above specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

It is understood that were one or more preferred ranges are given in the format x-y this includes the endpoints as well as all sub-ranges subsumed therein. All wt % are by weight of the total aerated food product composition, unless stated otherwise.

1. An aerated food product having an overrun of at least 20%, comprising 40-97% water, 3-50% (by weight, preferably 5-30%) of soluble and/or insoluble solids, and hydrophobin, wherein the aerated food product is a viscous liquid comprising salt and has a temperature of at least 50° C., preferably 50-130° C.

2. An aerated food product according to claim 1 wherein salt in the product is present in an amount of at least 0.01 wt %, preferably at least 0.05 wt %, more preferably at least 0.1 wt % by weight of the total aerated food product.

3. An aerated food product according to claim 1, which product is pasteurised or sterilised by subjecting to heat.

4. An aerated food product according to claim 1, which comprises at least 0.001 wt % hydrophobin.

5. An aerated food product according to claim 1, wherein the hydrophobin is in isolated form.

6. An aerated food product according to claim 1 wherein the hydrophobin is a class II hydrophobin.

7. An aerated food product according to claim 1, which is or has been heated to a temperature of at least 65° C.

8. An aerated food product according to claim 1, wherein the food product has an overrun of from 25 to 400%, preferably 50-200%, more preferably 80-120%.

9. An aerated food product according to claim 1, which maintains an overrun of at least 20%, preferably from 25 to 400%, preferably 50-200%, while being at a temperature of at least 50° C., preferably 60-130° C., for a time of at least 2 minutes.

10. An aerated product according to claim 1, which is a viscous liquid.

11. An aerated product according to claim 1, wherein the soluble and/or insoluble solids do not encompass fat or oil.

12. A process for producing an aerated food product according to claim 1, the process comprising:
a) aerating an aqueous composition comprising hydrophobin and soluble and/or insoluble solids to an overrun of at least 20%,
b) applying heat by having at least part of the remaining ingredients of step a) at a temperature of above 50° C. and/or by heating the mixture obtained by step a) to a temperature of above 50° C.

13. A process according to claim 12, wherein further fat or fat-containing ingredients are added at anyone stage after step a), followed by a mixing step.

14. A process according to claim 12, wherein the heating applied in step b) is such that the temperature of the final product has reached at least 50° C., preferably at least 65° C., optionally followed by cooling.

15. A process according to claim 12, wherein the heating is to temperatures of 75-130° C.
